(19) United States
(12) Patent Application Publication
(10) Pub. No.: US 2005/0221886 A1
(43) Pub. Date: Oct. 6, 2005

(54) Dice eye number determination method, dice eye number determination apparatus, game apparatus using same, and dice eye number determination game system

(75) Inventors: Fumihiko Itagaki, Hokkaido (JP); Satoshi Murakami, Hokkaido (JP)

Correspondence Address: MCGINN & GIBB, PLLC, 8321 OLD COURTHOUSE ROAD, SUITE 200, VIENNA, VA, 22182-3817, US

(73) Assignee: Hudson Soft Co., Ltd., Hokkaido (JP)

(21) Appl. No.: 11/070,159

(22) Filed: Mar. 3, 2005

(30) Foreign Application Priority Data
Apr. 3, 2004 (JP) 2004-060311

(51) Int. Cl. G06F 17/00; G06F 19/00

(52) U.S. Cl. 463/22

(57) ABSTRACT

The kind of plural dice within a screen in the box is determined based upon an image obtained by shooting one face of the dice rolled and a player for each dice is identified from the kind of the dice. The eye number of the plurality of the dice in one kind of the dice is determined based upon the determination condition of at least one of the feature, the number, and the location state of the points in a predetermined area in the image-shooting image. The determined eye numbers are displayed on a display, outputted in audio synthesis, or reflected in a game content. When the eye number determination is not made, the processing for the re-determination is performed.

The present application is based on Japanese patent application No. 2004-060311, the entire contents of which are incorporated herein by reference.

### BACKGROUND OF THE INVENTION

1. Field of the Invention

The present invention relates to a dice eye number determination method, a dice eye number determination apparatus, a game apparatus using the same, and a dice eye number determination game system, and in particular to a dice eye number determination method, a dice eye number determination apparatus, and a game apparatus using the same, and a dice eye number determination game system, which can automatically determine in image recognition eye numbers on a plurality of dice even when a plurality of players roll the plurality of the dice in the same location at a time.

2. Background Information

For example, a sugoroku game requires a dice as a tool to play the game. And some of hone video game machines, board games or the like require a dice. Conventionally determination of an eye number on a cast dice is performed by visual observation of game participants.

However, in games such as electronic game personal machines or electronic personal computers, almost all of game contents, game progresses, win-loss records and the like are displayed on an image display and these games are performed by operating a controller or a keyboard. In case a player who is familiar with games such as the game personal machines or the personal computers play a conventional sugoroku game, the player is not familiar with an old-fashioned game method in which a player rolls a dice with the player's hand and the eye number on the dice is visually determined by the player. On the other hand, the elderly are difficult to become familiar with a purely electronic game in which a game is performed by an operation of a controller.

And there is a case where a dice is used in anything other than a game. For example, in an arithmetic lesson in school, a math problem is set using a dice as a teaching tool. Since the dice is small, it is thought that students can not visualize a state of the dice, such as an eye number and an eye color clearly, which causes weakening recognition of participation in lessons and reducing the interest in lessons by half.

Therefore, Japanese Unexamined Patent Publication No. 08-215423 has disclosed a dice eye recognition apparatus that can electronically determine the number of eyes on a dice. In the apparatus, a magnetic piece is housed in each face of the numbers 1-6, a magnet generated in the magnetic piece is detected by a magnetic sensor, and a detection signal by scanning is processed in a process control circuit, thereby to determine the number of eyes on the dice.

However, according to the conventional apparatus of determining the number of eyes on the dice, since a special dice that houses a magnetic piece therein is necessary to use, a dice commercially sold in a toy store or the like is not useful for the conventional apparatus and can not be used therein. And since the dice eye number determination in the conventional apparatus is made on the assumption that the number of a player is one, the dice eye number determination can not be made efficiently in a case a plurality of players roll a plurality of dice together.

When in a game in which one player uses a plurality of dice, the plurality of the deice stop close to each other, a combination of eye numbers of the plurality of the dice forms an apparent eye number as one dice, which possibly causes an erroneous eye number determination.

Further, in a case a plurality of players throw a plurality of dice at a time, the plurality of the dice resultantly exist at the same location at a time. In this case, on top of determining the eye number of each dice, whose players the dice belong respectively to needs to be determined. And that determination is difficult to be automatically made.

In view of the above, there exists a need for a dice eye number determination method, a dice eye number determination apparatus, a game apparatus using the same, and a dice eye number determination game system which overcome the above-mentioned problems in the related art. The present invention addresses this need in the related art and also other needs, which will become apparent to those skilled in the art from this disclosure.

### SUMMARY OF THE INVENTION

It is an object of the present invention to provide a dice eye number determination method, a dice eye number determination apparatus, a game apparatus using the same, and a dice eye number determination game system, which can identify a player for each dice and determine an eye number for each dice even when a plurality of players respectively throw a plurality of dice at a time.

According to a first aspect of the present invention, a dice eye number determination method, comprises the steps of providing plural kinds of dice, each dice having at least six faces, describing from one eye to at least six eyes on each of at least the six faces, and having a feature to identify a player;
inputting the feature of the dice for each player by an inputting device or by shooting the feature by a shooting device; recording the inputted or shot feature by a recording device;
shooting at least one of an upper face or a lower face of at least the six faces of each dice of the plural kinds of the dice to generate an image signal; identifying a player for each kind of the dice out of the plural kinds of the dice within the shot face based upon the recorded feature and the image signal; and determining an eye number of each dice of the plural kinds of the dice within the shot face based upon the image signal.

According to the above method, the kind of the dice within the shot face is determined based upon the image signal and a player for each dice is identified from the kind of the dice, and an eye number of the dice is determined based upon at least one of the feature of eyes, the number of the eyes, and a location state of the eyes on the shot face. Thereby even when a plurality of players throw a plurality of dice at a time, a dice eye number can be automatically determined and further a player for each dice can be identified.

According to a second aspect of the present invention, a dice eye number determination apparatus, comprises plural kinds of dice, each dice having at least six faces and describing from one eye to at least six eyes on each of at least the six faces, and having a feature to identify a player; a shooting section to shoot at least one of an upper face or a lower face of at least the six faces of each dice of the plural kinds of the dice to generate an image signal; an input section to input the feature of the dice for each player for identifying the player; a recording section to record the inputted feature; a vessel wherein a space for rolling the plurality of the dice is defined and the shooting section is located in a lower part or an upper part thereof; a determination section to identify the player for each kind of the dice out of the plural kinds of the dice within the shot face based upon the recorded feature and the image signal and determine an eye number of each dice of the plural kinds of the dice within the shot face based upon the image signal; and an output section to display or output in a voice a determination result of the eye number for each player by the determination section as a numerical value, or output the determination result as dice information of an electronic game.

According to the above method, the eyes described on the dice rolled in the vessel are shot by the shooting section, the kind of the dice within the shot face is determined based upon the image signal by the shooting section, and a player for each dice is identified from the kind of the dice, and further, an eye number of the each dice for each kind is determined based upon a determination condition of at least one of the feature of the eyes, the number of the eyes, and a location state of the eyes within a predetermined area on the shot face, and the determination result is displayed and voiced and outputted as dice information. Thereby even when a plurality of players throw, a plurality of dice at a time, a dice eye number can be automatically determined and further a player can be identified.

According to a third aspect of the present invention, a game apparatus, comprises plural kinds of dice, each dice having at least six faces and describing from one eye to at least six eyes on each of at least the six faces, and having a feature to identify a player; a dice eye number determination section to identify the player for each kind of the dice out of the plural kinds of the dice within the shot face, as well as to determine an eye number of each dice of the plural kinds of the dice within the shot face based upon an image information provided by shooting at least one of an upper face or a lower face of at least the six faces of each dice of the plural kinds of the dice; a control section programmed to perform a game by a memory medium storing a game software or a game provided by a connection to an internet, display the image during performing the game on an internal or external display, as well as display on the display, output in a voice, or incorporate into the game as necessary a determination result with regard to the eye determination for each player obtained by determination of the dice eye number determination section.

According to the above apparatus, by the dice eye number determination section the kind of the dice within the shot face is determined and a player for each dice is identified based upon the image information with regard to the shot eyes for each dice, and an eye number of the each dice for each kind is determined/outputted based upon at least one of the feature of eyes, the number of the eyes, and a location state of the eyes within a predetermined area on the shot face. As a result, the eye number for each player is reflected in a game at the same time or is electrically displayed on an eye number display.

According to a fourth aspect of the present invention, a dice eye number determination game system, comprises a dice eye number determination apparatus comprising plural kinds of dice, each dice having at least six faces and describing from one eye to at least six eyes on each of at least the six faces, and having a feature to identify a player and a dice eye number determination section to identify a player for each kind of the dice out of the plural kinds of the dice within the shot face, as well as to determine an eye number of each dice of the plural kinds of the dice within the shot face based upon an image information provided by shooting at least one of an upper face or a lower face of at least the six faces of each dice of the plural kinds of the dice; and a game performing apparatus comprising a control section to perform a game by a memory medium storing a game software or a game provided by a connection to an internet, display the image during performing the game on an internal or external display, as well as display on the display, output in a voice, or incorporate into the game as necessary a determination result with regard to the eye determination for each player obtained by the dice eye number determination apparatus.

According to the above system, by the dice eye number determination apparatus the kind of the dice within the shot face is determined and a player for each dice is identified based upon the image information with regard to the shot eyes for each dice, and an eye number of the each dice for each kind is determined/outputted based upon at least one of the feature of eyes, the number of the eyes, and a location state of the eyes within a predetermined area on the shot face. As a result, the eye number for each player is reflected in a game at the same time or is electrically displayed on an eye number display.

### ADVANTAGES OF THE INVENTION

According to the dice eye number determination method in the first aspect of the present invention and the dice eye number determination apparatus in the second aspect of the present invention, since the kind of the dice within the shot face is determined based upon the image signal, a player is identified by this kind, and further, a determination of the eye number for each dice is automatically made, even when a plurality of players throw a plurality of dice in one play at a time, the eye number for each dice can be automatically determined. Thereby the player does not have to wait for another player to play a game, which leads to large reduction in a game time. And since the eye numbers of a plurality of dice of different kinds can be determined for each different kind, the dice of the different kind a player has can be used effectively.

According to the game apparatus in the third aspect of the present invention and the dice eye number determination game system in the fourth aspect of the present invention, since the kind with regard to the dice can be determined based upon the shooting result of the eyes of the dice obtained by the dice eye number determination section, even when a plurality of players throw a plurality of dice in one play at a time, a player for each dice can be identified, and further, since the eye number can be determined by analyzing the feature of the eyes described on the shot face, the eye number of the dice is not only automatically determined but also the progress of the game can be automated. And the game apparatus and the system can be applied to various games using a dice. Thereby a player does not have to wait for another player to play a game, which leads to large reduction in a game time.

These and other objects, features, aspects and advantages of the present invention will become apparent to those skilled in the art from the following detailed description, which, taken in conjunction with the annexed drawings, discloses preferred embodiments of the present invention.

### BRIEF DESCRIPTION OF THE DRAWINGS

Referring now to the attached drawings which form a part of this original disclosure:

FIG. 1 is a block diagram showing a constitution of a dice eye number determination apparatus in a first preferred embodiment;

FIG. 2 is a frame constitution view showing another example of an image-shooting section;

FIG. 3 is a frame constitution view showing a different example of an image-shooting section;

FIG. 4 is a flow chart showing an entire processing of a dice eye number determination method in the first preferred embodiment according to the present invention;

FIG. 5 is a flow chart showing another processing example of a dice eye number determination method in the first preferred embodiment according to the present invention;

FIG. 6 is a flow chart showing a detail of the dice eye number determination processing;

FIG. 7 is an explanation view showing how each of the eye numbers “1”-“6” of the dice appears;

FIG. 8 is a flow chart showing a detailed processing in S151 in FIG. 6;

FIG. 9 is a flow chart showing a detailed processing in S152 in FIG. 6;

FIG. 10A is an explanation view showing detailed location of each point of the eye number “6” on the dice;

FIG. 10B is an explanation view showing detailed location of each point of the eye number “6” on the dice;

FIG. 10C is an explanation view showing detailed location of each point of the eye number “3” on the dice;

FIG. 10D is an explanation view showing detailed location of each point of the eye number “6” on the dice;

FIG. 11 is a flow chart showing a detailed processing in S153 in FIG. 6;

FIG. 12 is an explanation view showing detailed location of each point of the eye number “5” on the dice;

FIG. 13 is an explanation view showing a state where three dice of the eye numbers “2”, “2”, and “4” are put together to falsely form the eye number “5”;

FIG. 14 is a flow chart showing a detailed processing in S154 in FIG. 6;

FIG. 15 is an explanation view showing a state where a plurality of dice are put together to form the eye number “4”;

FIG. 16 is an explanation view showing a point location in an eye pattern of the eye number “4” on the dice;

FIG. 17 is an explanation view showing a state where three dice, each having the eye number “2”, are put together to form the eye number “4”;

FIG. 18 is a flow chart showing a detailed processing in S155 in FIG. 6;

FIG. 19 is an explanation view showing a point location in an eye pattern of the eye number “3” on the dice;

FIG. 20 is an explanation view showing a state where two dice, are put together to form the eye number “3” in a contacting part;

FIG. 21 is an explanation view showing an example where in case three dice are put together, the eye number “2” or “3” is formed depending on their location relation;

FIG. 22 is a flow chart showing a detailed processing in S156 in FIG. 6; and

FIG. 23 is a block diagram showing a game apparatus in a second preferred embodiment according to the present invention.

### DETAILED DESCRIPTION OF THE PREFERRED EMBODIMENTS

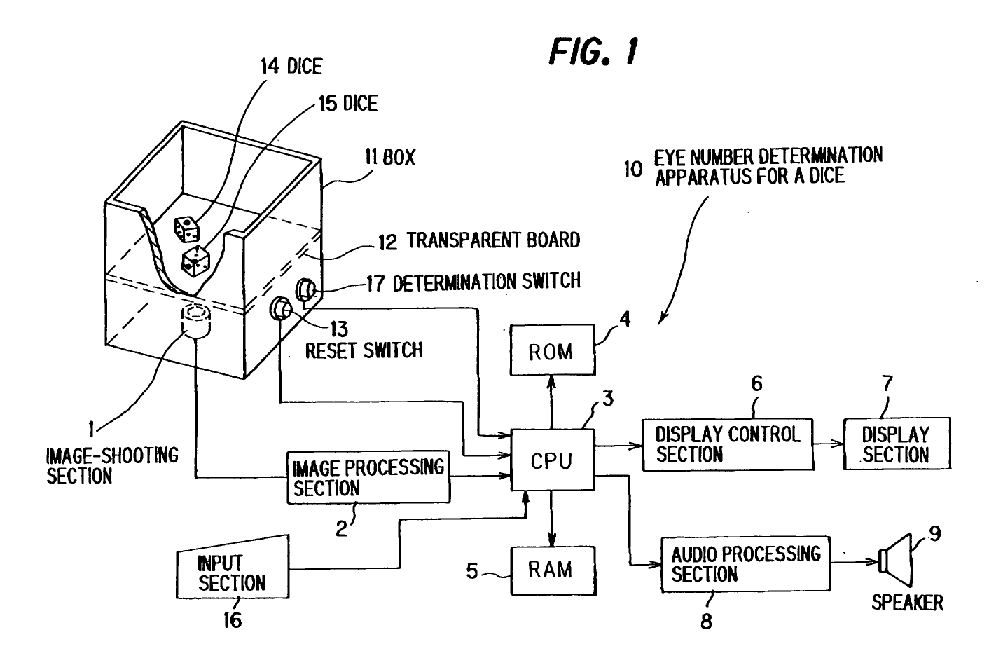

FIG. 1 is a block diagram showing a constitution of a dice eye number determination apparatus in a first preferred embodiment. A dice eye number determination apparatus 10 comprises an image-shooting section 1, an image processing section 2, a CPU 3, a ROM 4 (read only memory), a RAM 5 (random access memory), a display control section 6, a display section 7, an audio processing section 8, a speaker 9, a box 11 where dice 14, 15 are rolled, a transparent board 12 disposed inside the box 11, a reset switch 13, an input section 16 equipped with a numeric key pad capable of inputting hiragana, alphanumeric characters, symbols and the like by switching a mode, and a determination switch 17 that is operated in notifying the CPU 3 of “end of the throwing” after throwing dice.

It is noted that in fact the connection between the CPU 3 and other circuit sections is made through an interface (I/F), which is omitted herein. And a determination section is composed of the image processing section 2, the CPU 3, the ROM 4, and the RAM 5, and an output section is composed of each of the display control section 6 and the display section 7, and each of the audio processing section 8 and the speaker 9.

Dice 14, 15 are available in the market and a player basically prepares them by himself or herself, and the dice 14, 15 may be attached to the dice eye number determination apparatus 10 for selling. In FIG. 1, the eye number is displayed in numbers and also outputted by audio, but may be either of them.

The image shooting section 1 is formed of an image sensor that can read by color or white and black, such as a CCD (charge coupled device) or a MOS (metal oxide semiconductor transistor), and the shooting principle of the image sensor is the same as a digital camera. As described later, since the eye as the eye number “1” of the dice usually has red color, use of an image sensor to enable the color shooting is appropriate. However, since even in the image sensor in use for white and black, the red color is lighter reflected than the black color, or a point of the eye number “1” is usually different in size from the other eyes. This difference allows distinction between the eye as the eye number “1” and the eye as the other eye numbers. Therefore, the image sensor for white and black may be used.

It is noted that in case a player is a student in the lower grades in an elementary school or a preschooler, it is thought that the player tends to bring his or her face close to the box 11 or looks in the box 11. On this occasion, it is predicted that the image-shooting section 1 shoots both eyes of the player and recognizes the two eyes for the eye number “2” in error. Therefore, the image-shooting section 1 is equipped with a lens with a bright release F value to reduce depth of field, which allows only the dice to be clearly image-shot. Or an infrared sensor or the like may be disposed in the box 11 to detect that a player's face is coming close to the box 11 for emitting a warning.

In the image processing section 2, a digital processing of an image signal is carried out by the image-shooting section 1. The CPU 3 controls the entire apparatus, as well as processing shown in each flow chart as described later is carried out. The ROM 4 is a memory that stores programs for actuating the CPU 3 and can use a nonvolatile memory or a flash memory. The RAM 5 is a memory that temporarily stores setting values or processing results.

The display control section 6 performs control for displaying a determination result of the CPU 3. The display section 7 comprises a colored or a monochrome liquid crystal display, a cathode ray tube, and the like and displays the determination result with regard to the eye number made by the CPU 3. The audio processing section 8 performs voice synthesis of the determination result for outputting. The speaker 9 performs an electric-sound conversion with regard to an audio signal provided by the audio processing section 8 for outputting a voice.

The box 11 has an opening in an upper side thereof and has a transparent board 12 (transparent glass or transparent plastic) therein to divide the box 11 into two parts for forming an upper side and a lower side. A space above the transparent board 12 in the box 11 is a space for rolling dice. The image-shooting section 1 is installed on the bottom section. The image-shooting section 1 takes pictures of the lower faces of the dice 14, 15 as an object of shooting. Accordingly, when it is dark in the box 11, a clear picture can not be taken. Therefore, the box 11 is formed of a transparent plastic or glass, or a lamp for illumination is disposed in the vicinity of the image-shooting section 1 inside the box 11. Or an electronic flash (strobe) that momentarily emits light only in shooting an image may be used as a light source.

Further, a reset switch 13 and a determination switch 17 hang at a position within a player's easy reach on an outer wall of the box 11. Since the CPU 3 can not recognize whether or not all the dice have been thrown after the dice are thrown, an actuation of the determination switch 17 allows the CPU 3 to be notified and recognize that all the dice have been thrown inside the box 11. Or a sensor or the like to detect the dice may be provided to automate the notification. The reset switch 13 is operated for clearing the previous determination result in a case the dice 14, 15 (or one of them) are thrown after the dice has been rolled and the determination of the eye number for the dice has been made.

FIG. 1, when a player throws both the dice 14, 15 or one of them inside the box 11, the dice 14, 15 rolled on the transparent board 12 stop with time. The lower faces of the dice 14, 15 after stoppage are shot by the image-shooting section 1. The shot image is inputted in the image processing section 2, which is converted to a signal format that can be processed by the CPU 3. An image signal by the image processing section 2 is stored in the RAM 5 under control of the CPU 3. The CPU 3 checks image contents of the image processing section 2 according to the program of the ROM 4, to determine which of “1”-“6” the eye number on the dice 14, 15 is.

The determination result is displayed in numbers on a screen of the display section 7 through the display control section 6. Further, the determination result is outputted in a voice with voice synthesis by the audio processing section 8 and the speaker 9. In this case the audio output is performed only one time for one determination result, and the display on the display section 7 continues to be made until the next shooting timing.

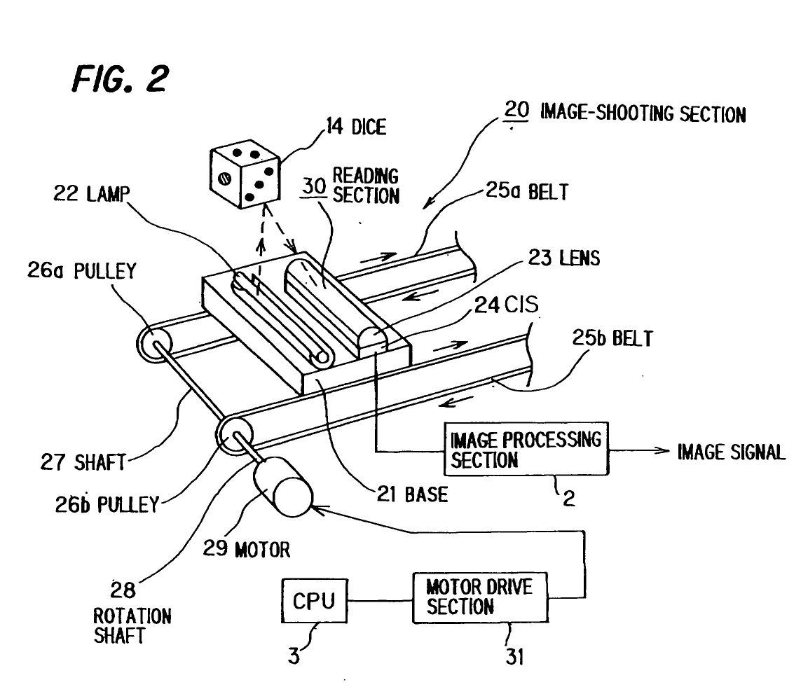

FIG. 2 shows another constitution example of an image-shooting section. The image-shooting section 20 is formed in a scanner principle known as a peripheral device of a personal computer, and disposed under the lower face of the transparent board 12 (on the bottom face of the box 11). The image-shooting section 20 comprises a base 21 reciprocating in the lower face of the transparent board 12, a lamp 22 (a fluorescent lamp, a white LED, or the like) for illumination, a reading section 30 composed of a lens 23, and a CIS 24 (Contact Image Sensor) and disposed in parallel to the lamp 22, belts 25a, 25b to reciprocate the base 21 under the lower face of the transparent board 12, pulleys 26a, 26b to rotatably support end sections of the belts 25a, 25b, a shaft 27 connecting the pulleys 26a, 26b, a motor 29 connected to the shaft 27 through a rotation shaft 28, and a motor drive section 31 to drive the motor 29 under control of the CPU 3.

It is noted that a chain may be used as an alternative of the belts 25a, 25b where a chain gear is used in place of the pulleys 26a, 26b. And a CCD image sensor may be used as an alternative of the CIS 24. In the case of using the CCD image sensor, an optical system as another example is adopted where a reflected image from a reading face is introduced through one or a plurality of mirrors and further through an imaging lens to the CDD image sensor.

In FIG. 2, when the motor drive section 31 is driven under the control of the CPU 3, power is supplied to the motor 29. The pulleys 26a, 26b are rotated by rotation of the motor 29 and the belts 25a, 25b are rotated in the direction of an arrow and at the same time the light 22 is switched on. The base 21 travels by rotation of the belts 25a, 25b. As the base 21 travels, the surface of the transparent board 12 is continuously illuminated by an area corresponding to the lamp length and a predetermined width by the lamp 22. The dice 14 is illuminated by this illumination and the reflected light from the lower face of the dice 14 is read in the reading section 30 and is supplied to the image processing section 2.

The image-shooting section 1 in FIG. 1 has the advantages that the number of the components is reduced and other than that, time required for image inputs is shortened since mechanical, movable parts are not used for image-reading. However, since a lens for imaging is used, extension of an image-receiving range lengthens a distance from a tip end of the image-shooting section 1 to the transparent board 12, namely heightens a location position of the transparent board 12 and as a result, it is difficult to reduce the entire height of the box 11. On the other hand, in the image-shooting section 20 in FIG. 2, the number of the components is increased, but since the thickness (height) of the image-shooting section 1 can be reduced, the location position of the transparent board 12 can be lowered. However, since the image-shooting section 20 performs the reading by traveling the reading section 30, image-reading takes more time as compared to the image-shooting section 1.

It is noted that the eye number is outputted such that the box 11 is stationary on a desk or a tatami mat and the dice is rolled on it, but the box 11 may be moved with the dice still put inside the box 11. In this case if the opening of the box 11 is wide, the dice tend to jump out of the box 11. Accordingly, it is preferable that a size of the opening of the box 11 is so small as to take in/out the dice and further, an entire weight of the box 11 is reduced.

And as in FIGS. 1 and 2, when the dice 14 (15) is shot from the lower face side thereof, since a player who has rolled the dice looks at the upper face of the dice 14, a difference in the eye number between the shot lower face and the upper face occurs. Therefore, it is necessary to correct a numerical value obtained by shooting the lower face with the eye number of the upper face. Namely a calculation of “7—an image shooting value” may be performed. For example, when a value obtained by shooting the lower face of the dice 14 is “6”, the eye number of the upper face of the dice 14 is admitted as “1”, and likewise when a value obtained by shooting is “2”, the eye number of the upper face of the dice 14 is admitted as “5”. However, the eye number of the lower face may be the eye number as it is and in particular in case a box in which an upper face of the dice can not be seen from an outside of the box is used, it is preferable that the eye number of the lower face is determined as the eye number as it is, in view of no necessity of the above calculation.

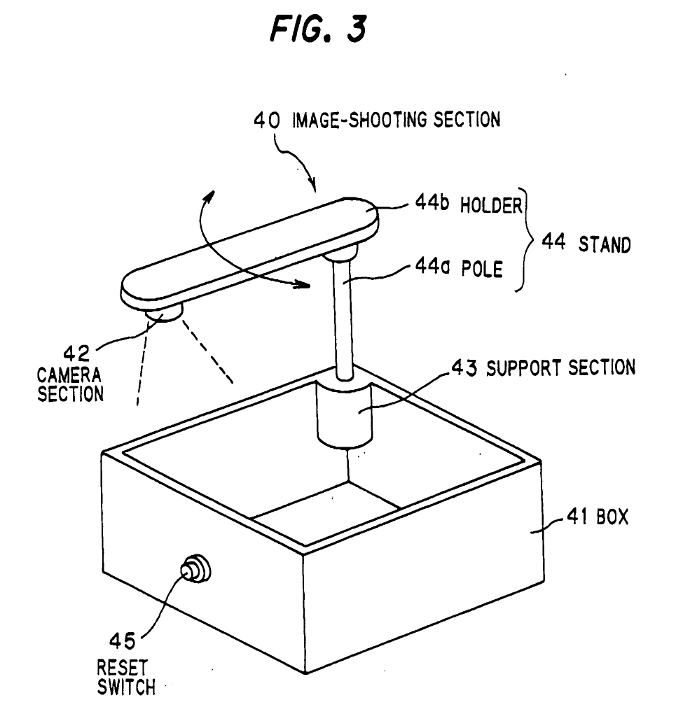

FIG. 3 shows a further example of an image-shooting section. An image-shooting section 40 is adapted to image-shoot the dice from above the box 41, as well as rotate a camera section 42 corresponding to the image-shooting section 1 in FIG. 1 within an angle of at least 45° and further retreat the camera section 42 from the box 41 when unnecessary.

A support section 43 is formed in one corner of the box 41 and a stand 44 is rotatably mounted and movable upward and downward to the support section 43. The stand 44 comprises a round rod shaped pole 44a, and a holder 44b that is mounted horizontally and rotatably at an upper end of the pole 44a. The holder 44b can be rotated horizontally with a hand and a tip of the holder 44b is moved from one section of the box 41 to a center of the box 41. The tip of the holder 44b is positioned to be above the center of the box 41 when the camera section 42 shoots the dice 14 or the like.

The camera section 42 is mounted to a tip of the holder 44b. The camera section 42 is formed of a camera, such as a combination of an optical lens and an image-shooting element of CCD or MOS and a lens, or a combination of the image-shooting element and the lens, further including an image processing section, and can take a picture of an entire bottom face of the box 11 within vision's field. Pushing an upper portion of the pole 44a causes the height thereof to be lowered, and lifting up the pole 44a causes the position of the holder 44b to be raised. And a reset switch 45 having the same effect with the reset switch 13 in FIG. 1 is mounted to a side face of the box 41.

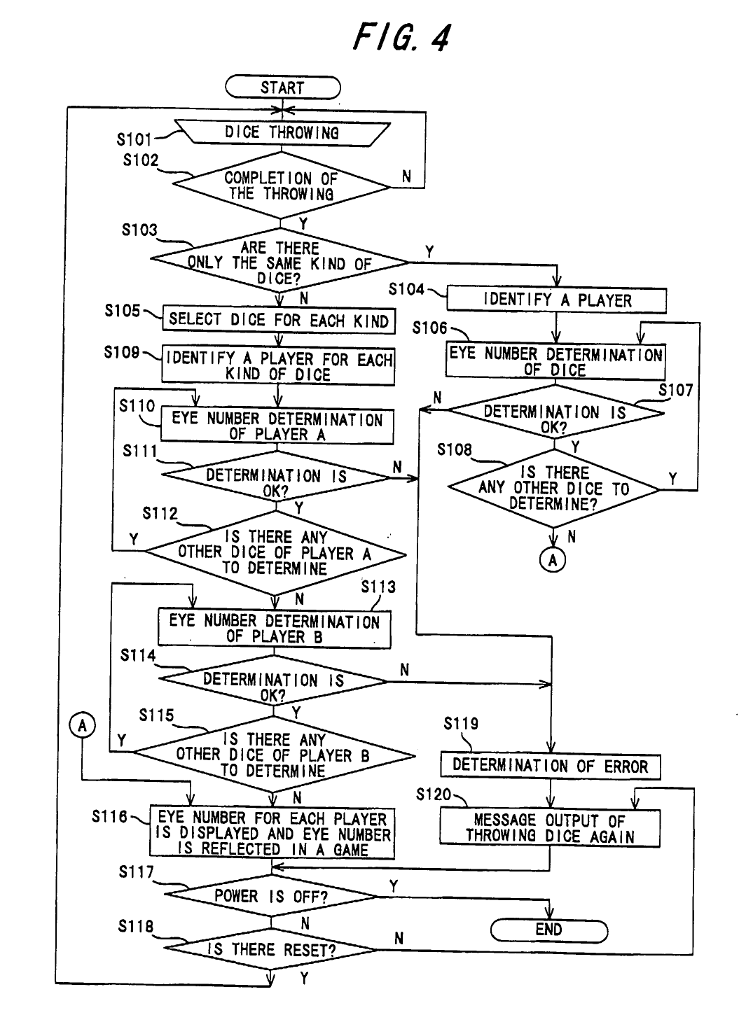

FIG. 4 shows an entire processing of a dice eye number determination method in the first preferred embodiment according to the present invention. Processing contents shown in FIG. 4 are stored as programs in the ROM 4. And as below, it is explained how a dice eye number determination is made in case two players (A and B) play a game, by using the dice eye number determination apparatus method 10 shown in FIG. 1. Two players (A and B) carry two dice respectively (either player carries the two dice with the same specification, but the two for the one player are different in specification from the two for the other player. Note that it may be not necessary for one player to carry the two with the same specification so long as the two dice for the one are different in specification from the two dice for the other). One of the two players throws two dice into the box 11, the other subsequently throws two dice into the box 11.

As a result four dice are thrown into the box 11 and thereafter, the eye number determination is adapted to be made. Note that “S” shown in the flow charts in the following figures including FIG. 4 indicates “step”.

The dice eye number determination apparatus 10 starts to operate by switching on the power source and then is initialized. Herein when a player “A” throw a plurality of dice into the box 11 at a time, the dice roll and move on the transparent board 12 in FIG. 1 and thereafter stop. Then a player “B” throws a plurality of dice into the box 11, the number thereof being the same as the player “B” (that is different from the two dice the player “A” throws) (S101). After the dice for the two players are thrown, one of the players pushes the determination switch, which causes the CPU 3 to be notified of completion of the throwing (S102).

The CPU 3 receives the completion of the dice throwing and then reads on the image from the shooting section 1 through the image processing section 2, analyzes the image within the screen, and determines the kind of the dice from the feature of each dice (S103). There is a case where after one player throws a plurality of dice, the player pushes the determination switch 17, and then the next player throws dice. In this case, a player is identified by assuming that one player throws one or more dice with the same specification (S104). When it is determined that plural kinds of the dice exist in the box 11, the dice are classified in groups for each kind (S105).

Identification of a player may be made in such a way that the kinds of dice to be used differ between players and a combination between the kind of the dice and a player is in advance registered. Other than input of the input section 16, data may be made by shooting dice placed on the transparent board 12 to be registered. A method of making the kinds of dice be different from each other between players comprises, for example making a color of an outer face of a dice for one player be different from that of a dice for the other player (in case an image processing of a color recognition is possible), making a color of eyes of a dice for one player (for example, a black and a color other than the black) be different from that of a dice for the other player, making a size and a font of eyes of a dice for one player be different from that of a dice for the other player, making a surface reflectance of a dice for one player be different from that of a dice for the other player, making a material (ivory, plastic, lumber, metal or the like) of a dice for one player be different from that of a dice for the other player, and making a contrast of a dice for one player when shot by the shooting section 1 be different from that of a dice for the other player. It is noted that in a case a boundary of a dice can be detected, the dice can be identified by image-recognizing the size (boundary) of the dice, which therefore, is a useful method. However, in fact it is difficult to clearly recognize the boundary of the dice without a camera having a high performance. Accordingly this method is difficult to adopt in the case of using a cheap camera. Or each dice can be recognized by providing recognition functions, such as coating a dice with fluorescent paint having different light-emitting color, providing a battery less type of oscillating circuit inside the dice and supplying power thereto by radio induction to generate an electric wave with a specified wavelength, mutually making light reflectance of dice surfaces of a dice be different from that of another dice, and making eyes be different for each dice, such as the eyes displayed by points, numerals, Roman numerals, picture characters, or the like.

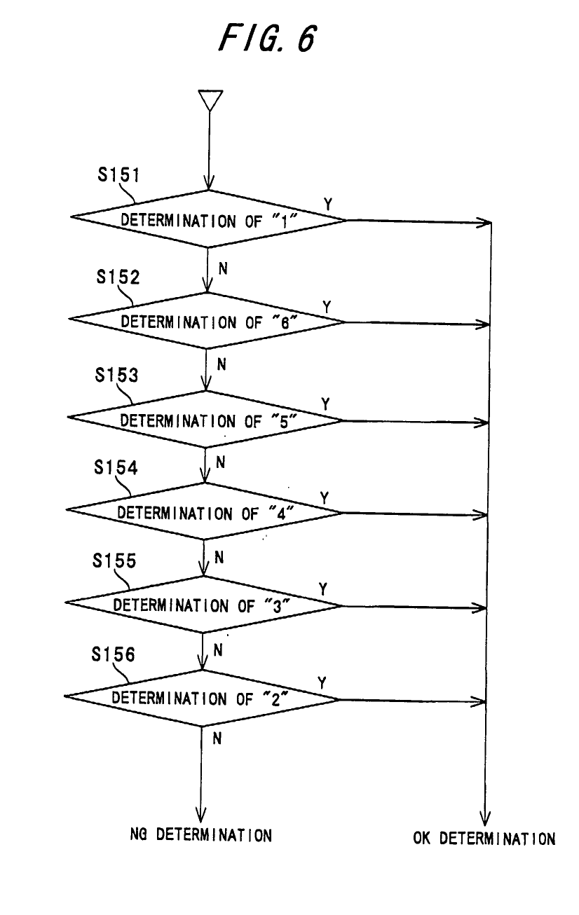

When a player is identified at S104, the image shot at the shooting section 1 is analyzed to determine which eye number of “1”-“6” is the eye number of the dice, and the determination process to be explained in FIG. 6 will be performed (S106). In a case in this determination processing, faces of the dice are dirty, sufficient illumination is not obtained, and a paint of an eye separates, it tends to become difficult to determine an eye number. Accordingly it is checked whether or not the determination is made (S107). When the determination is not made, the game does not proceed. Therefore, throwing a dice once more is demanded.

In case the eye number determination is confirmed at S107, the processing goes back to S106 for confirming dice eye number determination processing and determinations with respect to all the dice. In case the impossibility of the dice eye number determination occurs even in one out of a plurality of dice, throwing a dice again is demanded. Or again throwing only dice which can not be determined may be demanded.

On the other hand, in case plural kinds of dice are determined to exist in the box 11, each dice is selected for each kind thereof based upon feature information in advance registered with respect to each dice (S105), and a player is identified for, each kind of the dice (S109). The processing S105 and the processing S109 may be performed at a time. Identification of a player is performed in such a way that a difference in color (color of an entire dice, color of eyes or the like), a size, a display content (font) of a surface, a shape (round, angular or the like), or a material (ivory, plastic, lumber, metal or the like) between dice is determined based upon the image contents, and the resultant determination of the dice is compared with the corresponding features of the dice for each player registered beforehand. In case a player is not identified because of no prior registration, the processing goes to S105, wherein a message of “the processing can not proceed” and a message of “recommend a registration of a player” are displayed (not shown).

Herein a player “A” and a player “B” are assumed to be identified. First an eye number determination of one out of a plurality of dice with respect to the player “A” is made (S110). It is confirmed whether or not this eye number determination is achieved properly (S111). In case the eye number determination is achieved properly, an eye number determination for the next dice is made (S112). Namely the processing goes back to S110, and then the processing of S110-S112 is performed repeatedly.

When the eye number determinations with respect to all dice for the player “A” are finished, next an eye number determination of one out of a plurality of dice with respect to the player “B” is made (S113). It is confirmed whether or not this eye number determination is achieved properly (S114). If the eye number determination is achieved properly, the eye number determinations for all the other dice will be performed until the last one is finished (S115). In case the eye number determination is not confirmed at S114, an error is determined (S119), whereby a message or a voice of “recommend a player to throw dice again” (S120) is outputted, as well as is displayed on the display section 7.

When the eye number determinations with respect to all the dice the player “A” and the player “B” have thrown are finished, and when the processing at S108 is finished, the processing goes to S116, wherein the eye number of each dice for each player or a sum of the numbers of the eyes of the plurality of the dice is displayed on the display section 7. And the above finish is also announced in voice synthesis. Further, the eye number for each player is reflected in a game (S116). After this processing, it is determined whether or not the power has switched off (S117) and when the power continues to be on, it is determined whether or not the reset switch 13 is operated (S118). When the reset switch 13 is operated, the processing goes back to S101, and then the subsequent processing is performed repeatedly.

When a failure of the eye number determination is confirmed at S111 (and S107), an error is determined (S119), whereby a message of “recommend a player to throw a dice again” is outputted/displayed on the display section 7 (or a guide by voice synthesis may be made). When a player who has looked at this display or has heard of the audio guide pushes the reset button 13 (S118), the processing is returned back to S101, and then the subsequent processing will be performed repeatedly. It is noted that in the case of throwing a dice again, an operation of the reset switch button 13 is the condition for the throwing, but the reset may be automatically performed by image-recognizing a player's hand inside the box 11.

As described above, according to the first preferred embodiment of the present invention, not only in case a plurality of players play a game by throwing a plurality of dice in order, but also in case a plurality of players throw a plurality of dice at a time, each dice is automatically identified and further, the eye number can be automatically determined by associating each player with the dice used. Accordingly in case the first preferred embodiment is applied to a sugoroku game, a horse race game, or a game in which a piece is advanced in accordance with a dice eye number, since each player is not required to judge the dice eye number on his or her own, each player can focus on a game.

It is noted that in FIG. 4, the processing of a game by two players in view of a limited space is shown, but the first preferred embodiment can be applied to any number of players. In this case, the number of the processing of S110-S112 may increase corresponding to the number of players.

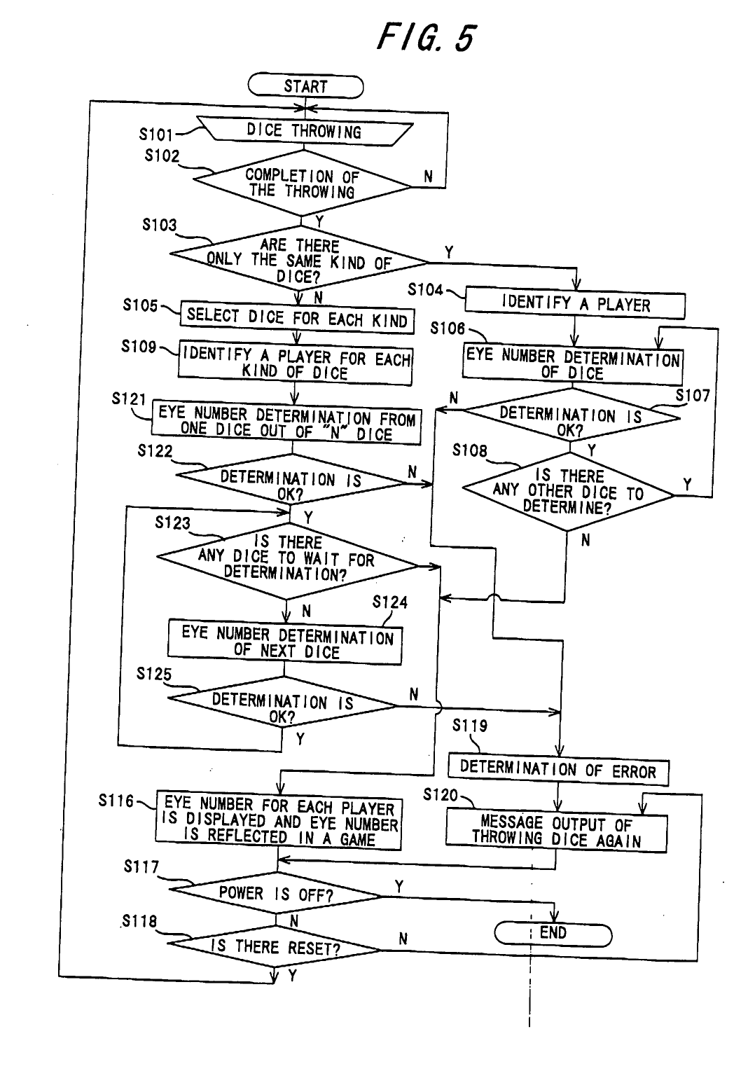

FIG. 5 shows another processing example in the first preferred embodiment of the present invention. In FIG. 5, the processing at S101-S109, and at S116-S120 is the same as in FIG. 4. Accordingly an explanation with respect to identical steps is omitted. In FIG. 4, after associating each dice with a player, a dice eye number determination is made for each player. On the other hand, the processing in FIG. 5 is characterized in that when associating each dice with a player is finished, the eye number determinations are made for all the dice indiscriminatingly in the order of the scanning on an image.

When the dice are selected for each kind thereof at S105, thereby a player is identified for each kind of the dice (S109). Accordingly the eye numbers of from one dice to N dice out of N numbers of dice are determined in order (S121). For example, the dice eye number determinations are made in the order in which the dice exist from a starting point of a sub-scanning direction of the image shot obtained by the shooting section 1 to a finish point thereof.

With respect to the order of the dice in this case, the dice for different players are lined irregularly. However, since it is all right only to recognize two aspects, that is, who the dice belong to, and what is the eye number of each dice, determining the eye number at a time results in no problem.

First, after the eye number determination for the first one dice is made, it is confirmed whether or not the eye number determination is finished properly (S122). The purpose of performing this determination is the same as at S107. Namely, this determination is made since in case the face of the dice is dirty, the sufficient illumination is not obtained, or the paint of the eye separates, the recognition of the eye is not made possibly.

In case the eye number determination is not made, an error is determined (S119). On the other hand, in case it is confirmed that the eye number determination is made, it is determined whether or not another dice waiting for an eye number determination exists (S123).

When the next dice exists, the eye number determination is performed (S124). It is confirmed whether or not the eye number determination for this next dice is finished properly (S125). When the eye number determination is not made, an error is determined (S119), and on the other hand, when it is confirmed that the eye number determination is made, the processing goes back to S123, wherein further, it is checked whether or not the next dice waiting for the eye number determination exists. In case the dice waiting for the determination exists, the eye number determination for the dice is made. This routine will continue to be performed to the last dice. When it is determined that there is no dice to determine an eye number at S123, the processing goes to S116, wherein the eye number of each dice for each player or a sum of the numbers of the eyes of the plurality of the dice for each player is displayed on the display section 7. And the above finish is also announced in voice synthesis. Further, the eye number for each player is reflected in a game. After this processing, it is determined whether or not the power has switched off (S117) and when the power continues to be on, it is determined whether or not the reset switch 13 is operated (S118). When the reset switch 13 is operated, the processing goes back to S101, and then the subsequent processing is performed repeatedly.

It is noted that in FIG. 5, it is explained that after the plurality of the dice are identified for each player, the eye number determination is performed for all the dice at a time in the order of the players, but the processing of the eye number determination for each dice and the identification of the player may be performed simultaneously.

And in FIGS. 4 and 5, it is explained that when an eye number determination failure is found for one dice thrown, throwing a dice again is required to do immediately after that. However, in case the eye number determinations with respect to the dice of the other players are performed properly, the processing after S116 may proceed with respect to the dice of the players the eye number determinations of which have been performed properly. With respect to the dice of the players the eye number determinations of which have failed to be made, a message of “appointing a player and throwing a dice again may be made at S120.

FIGS. 4 and 5 show a detail of the eye number determination.

The processing of the eye number determinations comprises mainly two steps as described below. The first step is to extract eyes (referred to as points in FIGS) of the dice from an image. The second step is to determine an eye number of the dice from a location relation or the like of the extracted points. Namely the eye number is determined based upon detection information such as a location relation, diameters or colors of the points. A dice is usually expected to have a clear contrast in a density (color) between the face and the point (eye) of the dice and therefore, the eye can be extracted based upon distribution and inclination of density values. Such processing enables the eye number determination even when the boundary between the dice closely placed is not distinct due to low resolution caused by low contrast in brightness or color between the face of the dice and the background thereof.

FIG. 6 shows a detail of the eye number determination processing of S106, S110 and S113 in FIG. 4, and a detail of the eye number determination processing of S106 and S121 in FIG. 5. It is noted that in case two or more dice exist in the box 11, in particular in case tow or more dice of the same kind exist, a plurality of dice are collected and neighboring eyes are combined, whereby a false eye number is formed (for example, two dice respectively show “2” as the eye number at the same time to form “4” as a false eye number, or respectively show “3” at the same time to form “6” as a false eye number). These eyes are possibly image-recognized as an eye number as one dice. With respect to such rare case, a more complicated processing is necessary, which will be explained later.

The dice eye number determination of FIG. 6 is performed by the CPU 3 based upon the image shot by the shooting section 1. The eye number determination is performed for finding which one out of the numerals “1”-6” is an eye number as one dice. The determination may be performed in no order, but the inventors have found that as shown in FIG. 6, it is the most efficient to determine the eye number of “1” first and thereafter the other eye numbers in order of “6”, “5”, “4”, “3”, and “2”.

It is required that the eye number “1” is determined first and then is excluded before determination of other eye numbers is made. Excluding the point as the eye number “1” first prevents the point showing the eye number “1” from being recognized as a part of a pattern of the other eye number in error. A dice available in the market has the feature that the point as the eye number “1” is larger in size than the points as the eyes of the other eye numbers, and is colored in red. Accordingly when the red color is included in the image-shooting information by the image-shooting section 1, it is determined immediately that the eye number of the dice is “1” (S151).

Since a dice does not have a unified standard in the industry organization, there is a slight difference in an outer size of the dice or an eye size of the dice between manufacturers. And there is a case the eye “1” is colored in black. Therefore, the eye number “1” is designed to be determined based upon anything other than colors. For example, in case the eye “1” is colored in black and a size of the dice is limited to a certain degree, the eye number “1” is determined not based upon the color of the eye but based upon a diameter of the eye, or the eye number is determined as “1” if the distance of the eye to the nearest eye is longer than one section out of the four sections of the dice.

In a case the eye number “1” is determined, the processing of S116 in FIG. 4 or FIG. 5 is performed. And in a case the eye number “1” is not determined, a determination of the eye number “6” is made (S152). In a case the eye number “6” is determined, the processing of S116 in FIG. 4 or FIG. 5 is performed after a predetermined processing. In a case the eye number “6” is not determined, a determination of the eye number “5” is made (S153). The eye numbers “4”, “3”, and “2” are determined in order in the same way as the above (S154, S155, and S156). In a case the eye number is not determined even in S156, it is possible not to obtain clear shooting images because of problems with a location of the box 11, stop positions of the dice 14, 15, illumination conditions, and the like. Accordingly, an error determination is made (S119) and a message to roll a dice once more is displayed or outputted in a voice (S106).

FIG. 7 shows featuring items of each eye as factors for determining the eye numbers of “1”-“6” for the dice. Each eye can be distinguished using the featuring items to determine the eye number. As shown in FIG. 7, the one eye as the eye number “1” is different from the eyes of the other eye numbers and has the feature in color (red circle or the like) or in size (a diameter thereof is greater than that of the eyes of the other eye numbers). A clearance between the eyes of “2” is different from a clearance between the eyes of “3”. The eye number “4” has two rows of two points, which are parallel with each other. The eye number “5” has five points located on the face to form the cross, and also the four points are located on a circumference of the same radius away from the center eye. Further, the eye number “6” has two rows of three points, and the two rows are parallel. The processing as explained below is performed based upon such feature with regard to the locations of the respective eyes of the dice.

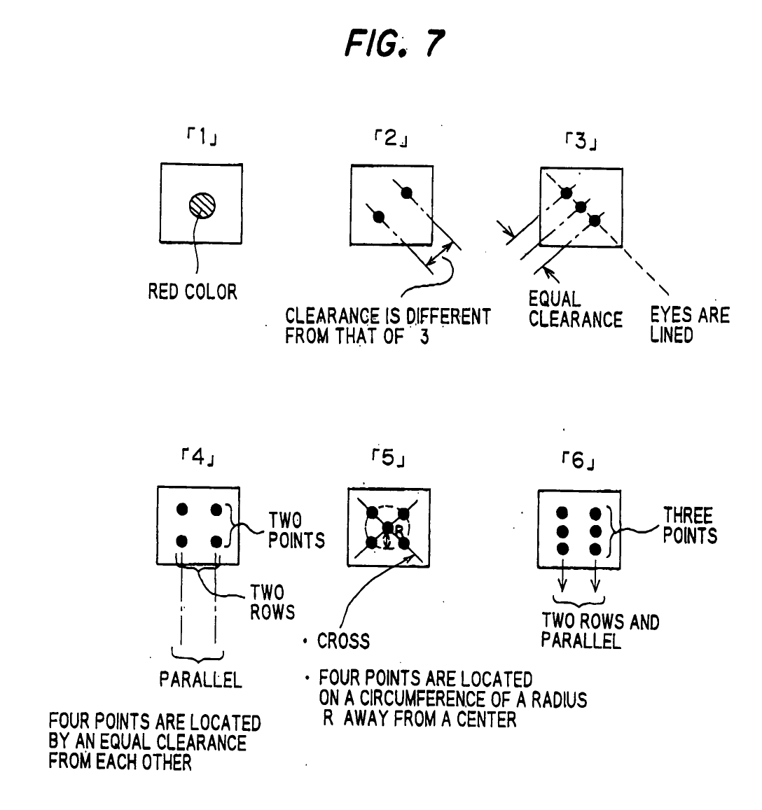

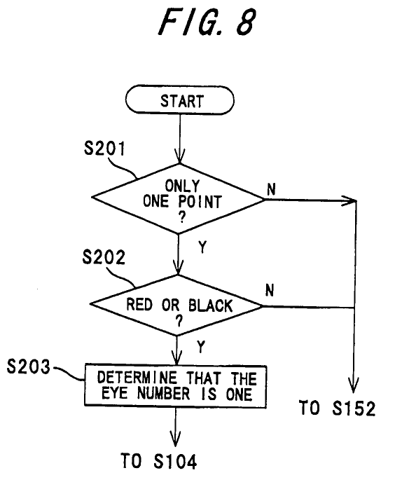

FIG. 8 shows a detailed processing of S151. When it is determined that the eye of the dice is one red point or one black point (S201, S202), it is determined that the eye number is “1” (S203) and thereafter, the processing goes to S116 in FIG. 4 or FIG. 5. And when it is not determined that the eye number is “1”, the processing goes to a determination processing for an eye number “6”.

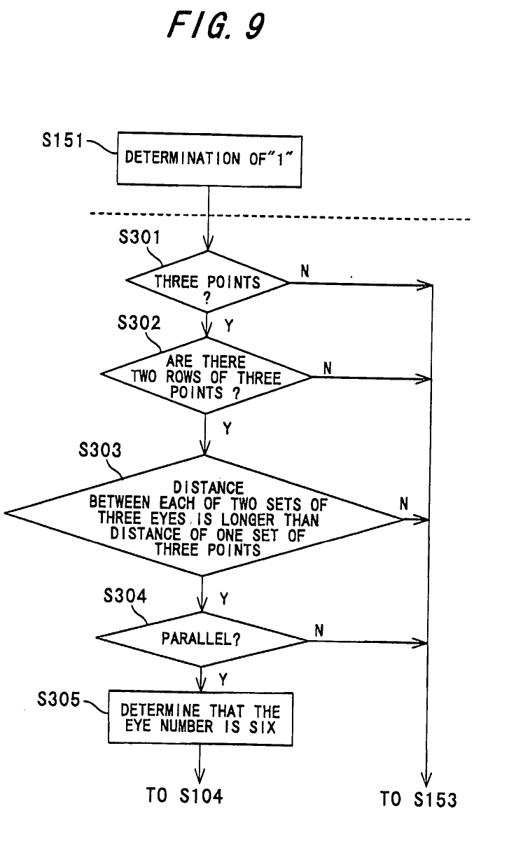

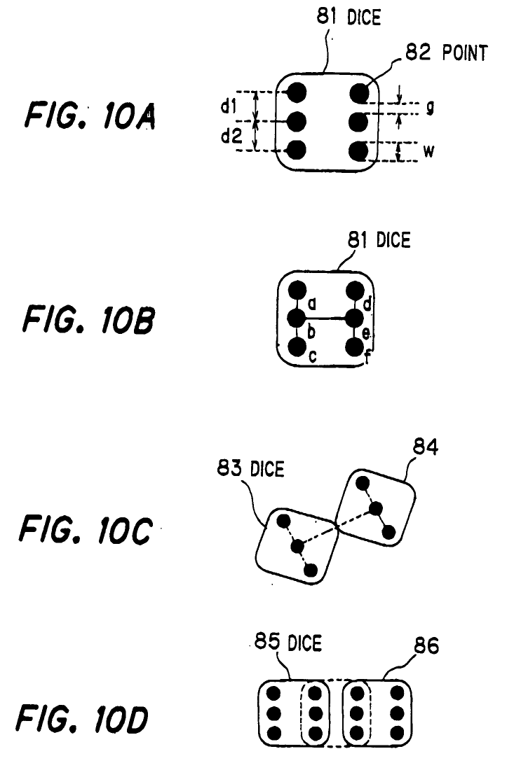

FIG. 9 shows a determination processing of the eye number “6”. And FIG. 10A, 10B, 10C and 10D show a detailed location of each point of the eye number “6”. In the eye number “6” of the dice as shown in FIGS. 7 and 10A, 10B, 10C and 10D, three points are closely in a line and two sets of the three points are located in two rows. As shown in FIG. 10C, there possibly occurs the event that the eye numbers of two dice 83, 84 both are “3” and the two dice are closely in a line. In this case, whether or not a distance between each three eye of one set and each corresponding three eye of the other set is shorter than a length of the one set (the length formed by three points) is set as a determination condition.

And in a case the two dice 85, 86 are contacted in a line, each showing the eye number “6” as shown in FIG. 10D, it is possible that three points of the one dice and the neighboring three points of the other dice are recognized to be the eye number “6” in error. In order to avoid such erroneous recognition, the sets of the three points shot are not set at random, but set for example in order from the left to the right and thereafter, the other points in the right and the left direction are determined.

With regard to the condition in order that a set of three points is determined to be “6” as the eye number, as shown in FIG. 10A, three points 82 of the dice 81 are in a line and a distance “d1” between the one and the center point is equal to a distance “d2” between the other and the center point (d1 is nearly equal to d2), and also the three points are very closely positioned. A clearance “g” between a point and a point is usually small than a diameter “w” of the point (g<w) and each of the distance “d1” and the distance “d2” is less than twice the diameter of the point (a distance “d” of the dice available in the market is mostly approximately 1.74 w).

Next a determination processing of the eye number “6” will be explained with reference to FIG. 9.

First, it is determined whether or not three points exist (S301) and next it is determined whether or not two sets of the three points are located in two rows (S302), and then it is determined whether or not a distance between each of the three points is longer than a length of one set formed with the three points (S303). Further, it is determined whether or not the two rows are in parallel and also in the square state (S304).

In a detail, as shown in FIG. 10B, it is determined whether or not the line of the points “a”-“c” is parallel to the line of the points “d”-“f”, as well as the line of the points “a”-“c” (or “d”-“f”) is substantially vertical to the line of the points “b”-“e” (or, the points “a”-“d” or the points “c”-“f”). Or it may be determined whether or not the line of the points “a”-“c” the same in length as the line of the points “d”-“f”. And it is determined whether or not the line of the points “b”-“e” is longer than the line of the points “a”-“c” or the line of the points “d”-“f” so that a state where two dice each having the eye number “3” are placed parallel to each other is not recognized in error to be the eye number “6”. In a case the line of the points “b”-“e” is longer than the line of the points “a”-“c” or the line of the points “d”-“f”, it is determined that the eye number is not “6”. It is noted that the line of the points “a”-“c” or the like indicates a distance or a length between two points (“a” and “c”).

FIG. 10D shows a case where two dice 85, 86, each having the eye number “6” is adjacently and also in the same direction placed. In this case it is possible to recognize the eye number “6” with a combination of three points of one dice and three points of the other dice. Accordingly, in coping with this problem, sets of three points shot are set not at random, but in order from the right to the left.

According to the determination processing described above, the eye number “6” can be recognized. If the determination of the eye, number “6” is made prior to determination of the other eye numbers, loads in the subsequent determination processing are reduced, which enables earlier finish of an entire determination processing.

In a case the above three conditions are cleared, the eye number “6” is determined (S305), the processing goes to S116 in FIG. 4 or FIG. 5 after a predetermined processing. And in a case even one of the three conditions is not cleared, the eye number “6” is not determined and the processing goes to S119 in FIG. 4 or FIG. 5. The earlier determination of the eye number “6” in FIG. 7 brings out reduction of loads in subsequent processing, thereby to provide earlier finish of an entire processing in FIG. 4.

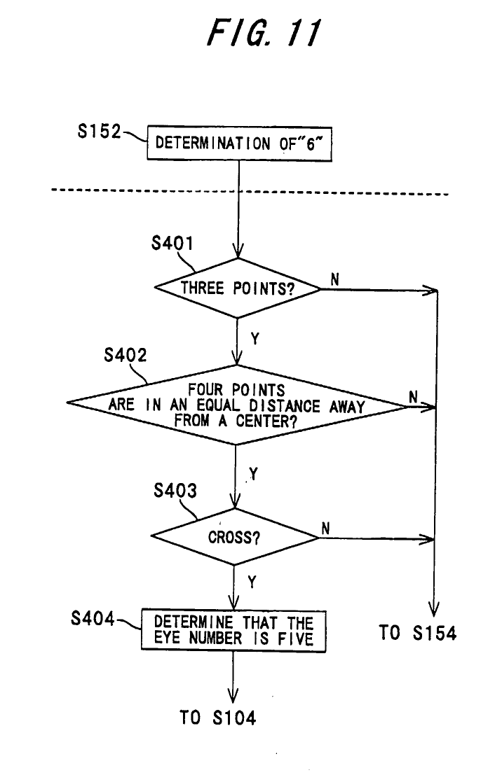

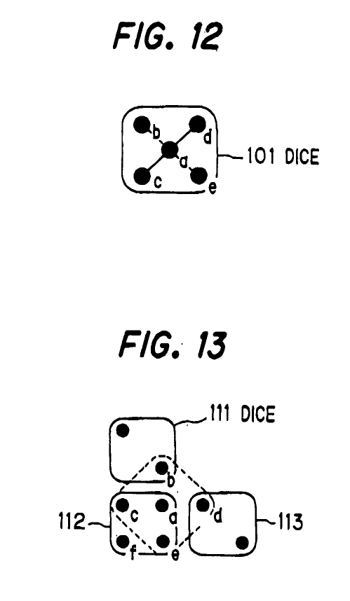

FIG. 11 shows a determination processing of the eye number “5”. FIG. 12 shows a location of the eyes of the eye number “5”. In the eyes of the eye number “5”, as shown in a dice 101 in FIGS. 7 and 12, four black points are located on the four corners of a quadrangle and one black point is located in the center thereof. In other words, since the black points are located in the shape of a cross, it is determined that the eye number is “5” depending on whether or not the five black points are located in the shape of a cross. According to further consideration, in the eye number “5”, four black eyes surrounding the black point in the center are in the same distance away therefrom. Accordingly it is the condition for the determination of the eye number “5” whether or not the black points are located in the shape of the cross and the four black points are located in the same distance away from the center.

First, it is determined whether or not the number of black points is three points (S401). This processing is because of recognition for the center of the cross. In a case three black points exist, it is determined whether or not four black points are located in the same distance away from the center of the three points (S402). Next, in a case four black points exist in the same distance away from the center, it is determined whether or not the black points are located in the shape of the cross (at right angles) as a whole (S403).

Namely the eye number “5” is determined based upon whether or not five points shown in FIG. 12 have the relation as shown below.
|“a”−“b”|≈|“a”−“c”|≈|“a”−“d”|≈|“a”−“e”| (equal clearance)
(“b”−“e”·“c”−“d”)/(|“b”−“e”|·|“c”−“d”|)≈0 (vertical crossing)

In a case the above condition is cleared, it is determined the eye number is “5” (S404), the processing goes to S116 in FIG. 4 or FIG. 5. And in a case even one of the three conditions is not cleared, it is not determined that the eye number is “5”, and the processing goes to S119 in FIG. 4. It is noted that the determination of the eye number “5” is made based upon the condition that any point of the five points does not have the feature of the point as the eye number “1”. However, if the determination of the eye number “1” is, as shown, in FIG. 6, made before the determination processing of the eye number “5”, the processing of this confirmation is not necessary.

FIG. 113 shows a case where three dice 111, 112, and 113 stop in a collective state, as well as the eye numbers thereof become respectively “2”, “2”, and “4”. In this case the eye number “5” is formed in the center of the three dice as shown in a dotted line. The processing of this case will be explained as below.

Since an eye number pattern of “5” in this case is larger in size than an actual dice, it is determined that the eye number is not “5”, and this pattern can be excluded from the determination results. It is noted that there is a method of determining that the eye number is not “5” based upon the condition except for the size of the dice. Namely it is determined based upon whether or not a point “f” forming a part of an eye number pattern of “4” exists in the vicinity of the dice 112 having the points “a”, “c”, and “e” of the eye number “5”.

If the point “f” is found, it is assumed that the eye number shown in a dotted line by the five points “a”, “b”, “c”, “d”, and “e” is not “5”. The reason is that if the points “a”, “b”, “c”, “d”, and “e” are the points of the eye number “5” of the dice, the point “f” does not come close to the dotted line showing the border. The inventors have confirmed that this respect is correct by checking various kinds of dice available in the market.

It will be confirmed by the above similar method whether or not another point (for example, the point “X”) having the feature similar to the point “f” exists in the other three eye number patterns of the points “a”, “b”, and “c”, the points “a”, “b”, and “d”, and the points “a”, “b”, and “e”. For example, whether or not the point “X” is paired to the points “a”, “c”, and “e” to form the eye number pattern of “4” can be determined based upon whether or not a set of the points “a”-“x” is substantially as long as a set of the points “c”-“e”, and also each set is crossed in the vicinity of respective centers.

The eye number “5” can be recognized by the determination processing described above. An earlier determination of the eye number “5” causes easier processing of subsequent other eye number determinations to shorten finish time of an entire processing. And the eye number determination of “5” can be incorporated in a method of “the processing starts with an end point” described later. In this case, with no possibility of erroneous recognition of the eye number “4” of the dice, the determination processing of the eye number “5” becomes simple.

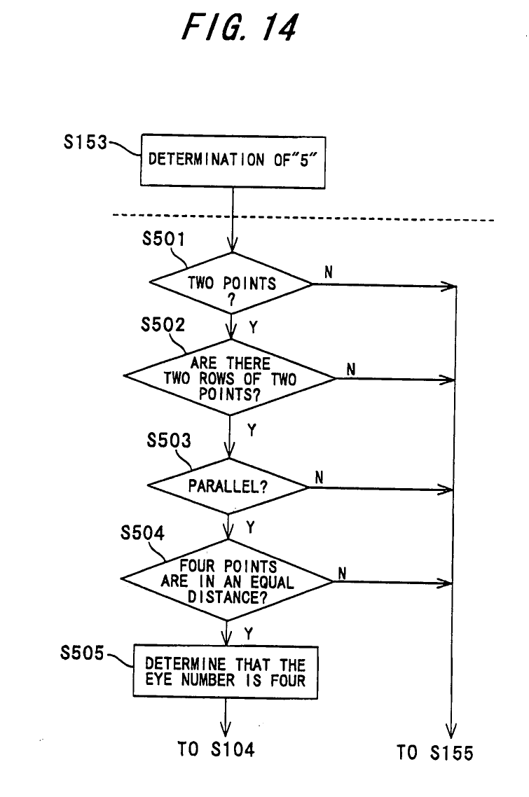

FIG. 14 shows a determination processing of the eye number “4”. In the eye number “4”, as shown in FIG. 7, four black points are vertically arranged. Accordingly when the four black points exist, the eye number “4” is nearly determined. According to further consideration, if in four points, two lines, each connecting two black points, are respectively crossed vertically, and each line has substantially the same and appropriate length, and the crossing point of the two lines is in the vicinity of the respective centers, it is found that the eye number is “4”. And there is a possibility that two points of each of the two dice come close to seemingly form the eyes “4”. Accordingly whether or not the four black points are located in an equal distance is also included in the determination condition.

First, it is determined whether or not the number of the eyes of the dice is two points (S501). Next, it is determined whether or not there are two rows of two points (S502). The four points to show the eye number “4” are recognized based upon this determination. Next, it is determined whether or not two rows of the two points are parallel (S503), and further, it is determined whether or not each of four points is mutually in an equal distance from two points adjacent thereto (S504). When each condition described above is cleared, it is determined that the eye number is “4” (S505), the processing goes to S116 in FIG. 4 or FIG. 5 after a predetermined processing. On the other hand, when even one of the four conditions is not cleared, it is not determined that the eye number is “4”, and the processing goes to S119 in FIG. 4 or FIG. 5.

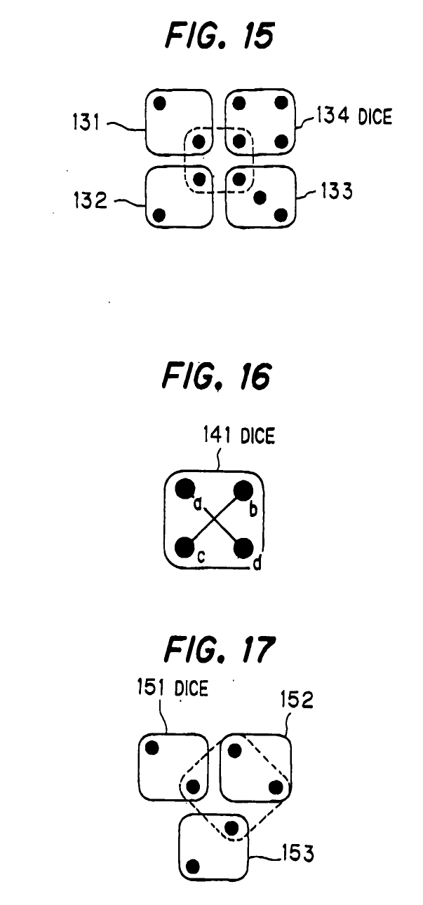

FIG. 15 shows a case where a plurality of dice are rolled to be placed in a collective state to form the eye number “4” in the center. As an example to form such eye number pattern, there is a case four dice 131, 132, 133, and 134 are located in a collective state to form a quadrangle as a whole, and the respective eye numbers are shown as “2”, “2”, “3”, and “4”. In this case the eye number “4” is formed in the center as shown in dotted line. Since in this case, not only the eye number “4” but also the other eye number patterns such as the eye numbers “2”, and “3” are possibly determined, the eye numbers can not be simply determined unlike the eye number “6” or “5” described above.

Therefore, based upon a point in the outmost end in an image, an eye number of a dice including the point of the outmost end is processed by a method explained below.

This processing will be repeated by setting the point existing in the outmost end in the image as a base in order until any unprocessed point does not exist. This allows the eye numbers “4”-“2” to be determined. It is noted that in the process of performing this processing, the determination of the eye numbers “1”, “5”, and “6” is possible to make. This processing will be explained in detail later.

This processing determines, in order based upon the point (unprocessed end point) existing in the outmost end in an image, that the eye number is “1”, “6”, “5”, “4”, “3”, or “2”. For example, a distance between the points is used for identifying the point in the outmost end in the image (first unprocessed end point). Since two points having the longest distance therebetween in the image are the points positioned in the outmost end in the image, it is all right only if the respective two points or either one of the two are processed. When the eye number with regard to points including a point (first unprocessed end point) existing in the outmost end in the image is determined and its processing is finished, the near unprocessed point is set as an unprocessed end point (second unprocessed end point) and will be processed in order.

First, if the end point unprocessed in the image has the feature of the point as the eye number “1” described above, the eye number is determined/confirmed as “1”.

If recognition of the eye number “1” is finished, it is not necessary to determine a determination of the eye number “1” newly.

Next, it will be determined whether or not the eye number is “6”. If the end eye unprocessed in the image is a part of the eye number “6”, that part is the end point in the three points closely placed in series in the eye number pattern of “6”, and a point closest to the end point is a central point of the three points. If the above eye number pattern of “6” corresponds to this state the eye number is determined to be “6”. It is noted that herein the false eye number pattern “6” as shown in FIG. 10D is not necessary to consider. In this case, if the recognition of “6” is finished, it is not necessary to perform the determination of “6” newly.

Next, following the determination of whether or not the eye number is “6”, it will be determined whether or not the eye number is “5”. If the end point unprocessed in the image is a part of the eye number “5”, the end point is any one of four points other than the central point out of the pattern of “5”, and the point closest to the end point is the central point of the pattern “5”. If the pattern of “5” corresponds to this condition, the eye number “5” can be determined. In this case, consideration of the false eye number pattern “5” as shown in FIG. 13 is not necessary, and a limit to a clearance between points may be set in accordance with a size of the dice. In this case, if the recognition of the eye number “5” is finished, it is not necessary to perform a determination of the eye number “5” newly.

Next, it is performed to determine whether or not the eye number is “4”. If the end point “a” unprocessed, as well as the points “b”, “c”, and “d” forming the eye number pattern “4” exist in the image, the point “a” is a part of the eyes of the eye number “4” or “5”. However, it is the condition that any point does not have the feature of the point as the eye of the eye number “1”. It is noted that if the determination of “1” is determined in advance, this determination is not necessary.

FIG. 16 shows an eye location of the eye number pattern “4”. In FIG. 14, whether or not four points of the dice 141 show the eye number pattern “4” can be determined based upon the following equation.
Condition 1: |“a”−“d”|≈|“b”−“c”|
Condition 2: (“a”−“d”·“b”−“c”)/(|“a”−“d”||“b”−“c”|)≈0 (vertical crossing)

Condition 3: A line component “ad” and a line component “bc” are crossed respectively in the vicinity of the center of each line.

Further, it is predicted that a plurality of dice are collected to form the eye number “4”.

FIG. 17 shows a case where three dice, each having the eye number “2”, are collected to form the false eye number pattern “4”. In order to exclude that the false eye number “4” is determined in such case, a limit to a clearance between points is required to be set in accordance with the size of the dice. For example, a size of the dice used may be restricted to define a certain value to the limit or the limit may be changed based upon a diameter or the like of the point (eye).

If the points “a”, “b”, “c”, and “d” meet the above conditions 1-3, the points “a”, “b”, “c” and “d” can be assumed to be a part of the eye number “4” or “5” Accordingly in a case it will be determined whether or not the eye number is “4” after it is determined whether or not the end point “a” is a part of the eye number “5”, since at this timing the eye number is never “S”, it can be determined immediately that the points “a”, “b”, “c” and “d” is the part of the eye number “4”. Or it may be checked whether or not another point exists inside the points “a”, “b”, “c” and “d”.

When the end point “a” unprocessed in the image does not correspond to anyone of the determination conditions of the above-mentioned eye numbers “6”, “5”, and “4”, the eye number may be assumed to be the eye number “3” or “2”. Namely if a point forming the eye number pattern “3” together with the end point “a” and the point “b” closest to the end point “a” exists, the points “a”, “b”, and “c” are a part of the eye number “3”.

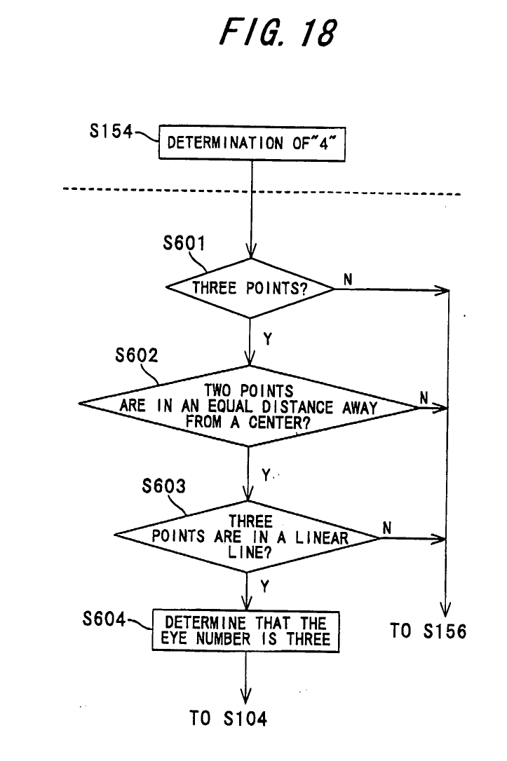

FIG. 18 shows a determination processing of the eye number “3”.

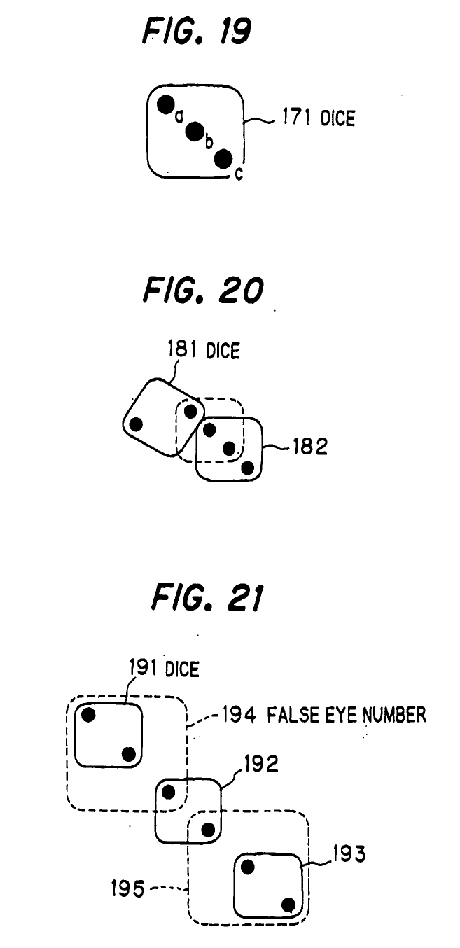

FIG. 19 shows a point (eye) location of the eye number pattern “3”. In FIG. 19, whether or not three points “a”, “b”, and “c” of the dice 171 show the eye number pattern “3” can be determined based upon the following conditions. The eye number “3” of the dice 171, as shown in FIG. 7, is a pattern where three black points are arrayed. Accordingly if the two points exist in an equal distance away from the center and in a linear line, the eye number “3” can be determined. Namely when the following two conditions are met, the eye number “3” can be determined.
Condition 1: |“a”−“b”|≈|“b”−“c”| (equal clearance)
Condition 2: (“a”−“b”·“b”−“c”)/(|“a”−“b”||“b”−“c”|)≈1 (series)

The determination processing of the eye number “3” will be explained with reference to FIG. 18. First, it is determined whether or not the number of black points is three points (S601). Only this determination does not enable distinction to three points lined obliquely in the eye number “5”. Accordingly it is determined whether or not two black points are located in the same distance away from the center of the three points (S602). Next, in a case two black points exist in the same distance away from the center, it is determined whether or not the three black points including the two black points are located in a linear line (S603).

In a case the above conditions are cleared, it is determined the eye number is “3” (S604), the processing goes to S116 in FIG. 4 or FIG. 5. And in a case even one of the three conditions is not cleared, it is not determined that the eye number is “3”, and the processing goes to S119 in FIG. 4 or FIG. 5 after a predetermined processing.

FIG. 20 shows a case where two dice 181, 182 are located in a collective state and three eyes are formed in the contacting portion between the two dice. In a case the eye number of the dice 181 is “2” and the eye number of the dice 182 is “3”, the eyes of the eye number “3” are formed by two points of the dice 182 and one point of the dice 181. The processing to prevent the eyes “3” in this state from being determined as the eye number “3” in error is the same as in a case in FIG. 15 and consideration is paid to the point positioned in the outmost end in the image, which may be processed using the distance between the points.

In a case the point to meet the two determination conditions of the eye number “3” does not exist, two points “a”, “b” are determined as the points of the eye number “2”. However, for determinations of the eye numbers “3” and “2”, it is the condition that any one of the points does not have the feature of the point as the eye number “1”. It is noted that when it is already determined that the eye number is “1”, this determination is not necessary.

FIG. 21 shows a case where when three dice are collected, the eye numbers “2” and “3” are formed depending on the location relation of the three dice. For example, six points of three dice 191, 192, 193, each having the eye number “2”, are located in a linear line, two sets of the eye number “3” shown in a dotted line frame and one set of the eye number “2” of the dice 192 between the two sets tend to exist in the linear line. Namely false eye numbers 194, 195 tend to be generated. However, the false eye numbers can be distinct based upon a clearance between the points. An allowance range of the clearance between the points may be dynamically defined by limiting the size of the dice or based upon a diameter or the like of the point.

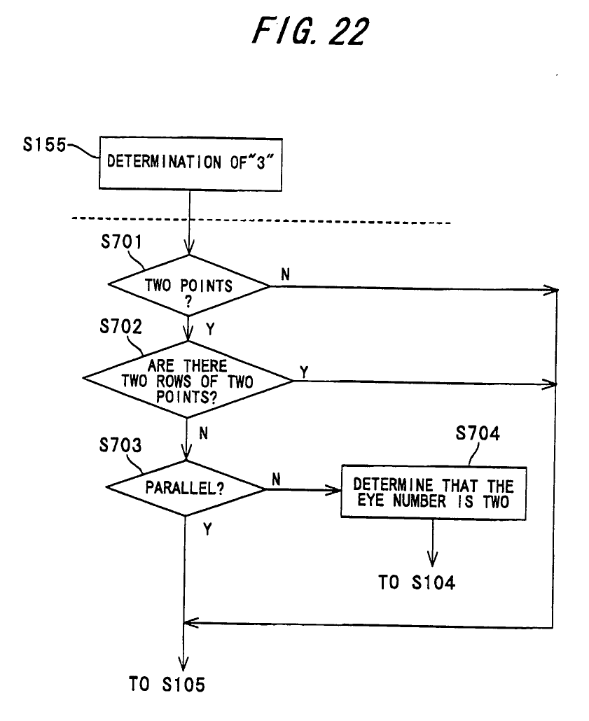

FIG. 22 shows a determination processing of the eye number “2”. The eyes of the eye number “2” of the dice, as shown in FIG. 7, has two eyes. The eye number “2” is determined as “2” based upon that two black points are in a line, as well as the eye number “2” is not a square shape (distinction to the eye number “4” is possible by it) However, an erroneous recognition with regard to the eye numbers “2”, “3” possibly occurs depending on the location relation, and the erroneous recognition can be avoided based upon the clearance between the points.

First, it is determined whether or not the number of the eyes of the dice is two points (S701). Next, the eye number is determined as “2” (S704) based upon a state where two points are not formed by two rows of one point and two rows of two points are not parallel unlike the eye number “4” (S702, S703), and then the processing goes to S116 in FIG. 4 or FIG. 5. When even one of the determinations of S701-S703 is not cleared, it is not determined that the eye number is “2”, and the processing goes to S119 in FIG. 4 or FIG. 5.

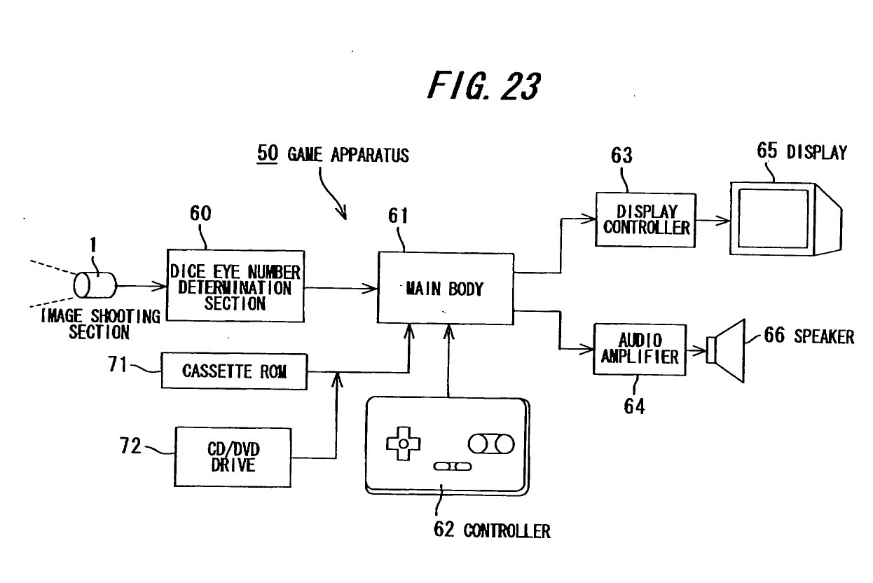

FIG. 23 shows a game apparatus in a second preferred embodiment according to the present invention. This game apparatus comprises the dice eye number determination apparatus 10 and the image-shooting section shown in FIGS. 1-3, and is suitable for a game such as a sugoroku game, a horse race game or a game in which a piece is advanced in accordance with a dice eye number, and more particularly for a game which a plurality of players play. As the number of players increases, this game apparatus is more effective.

The game apparatus 50 comprises a dice eye number determination section 60 having substantially the same components with the dice eye number determination apparatus 10, a main body section 61 to which a cassette ROM 71 or a CD/DVD drive 72 is mounted, a controller 62 for games operated by a player, a display controller 63 for display control, a display 65 connected to the display controller 63, an audio amplifier 64 connected to the main body section 61 to amplify voices, and a speaker 66 connected to the audio amplifier 64 to output voices.

The dice eye number determination section 60 is formed of the dice eye number determination apparatus 10 excluding the display control section 6, the display section 7, the audio processing section 8, and the speaker 9 in FIG. 1. The excluded functions are performed by the display controller 63 connected to the main body section 61, the display 65, the audio amplifier 64, and the speaker 66 as alternatives.

The main body section 61 is a computer comprising a CPU, a ROM, a RAM, a bus interface, an input/output interface, and power source section and is operated by programs stored in the ROM. The controller 62 for the game is operated by a player in playing a game, and is equipped with a function key, a cross key, and other keys and is connected to the main body section 61 through a cable. The display 65 may be formed of a CRT, a crystal display or the like.

Herein the display 65 is a display exclusively for games, but if the display 65 is connected to the main body section 61 through a converter converting a picture signal, a receiver for TV broadcasting may be used as a display. And the main body section 61, the display 65, and the dice eye number determination section 60 are formed separately. However, these components and further the display controller 63, the audio amplifier 64, the display 65, the speaker 66, and the CD/DVD drive 72 housed in the display 65 may be integrally formed. In reverse, the display 65 and the other components may be housed in the main body section 61 for integration.

In the case of using the game apparatus 50, the use aspect may be provided such that game software using a dice is actuated to be incorporated in the game or may be simply used as a dice eye number determination/a display apparatus. When a player starts to play a game by mounting the cassette ROM 71 or by setting the CD/DVD for games to the CD/DVD drive 72, the progress of the game is displayed from point to point. The game advances by operating the game controller 62 for the game. And Voices in the game are outputted through the audio amplifier 64 from the speaker 66.

In a case a game requires a dice, a message is displayed on the display 65 in requiring the dice (or voices are outputted). Accordingly when a player throws dice into the box 11 and rolls them, the eye number is read by the dice eye number determination apparatus 10. The read contents are processed by the dice eye number determination section 60 as described above, and the determination information is sent to the main body section 61. The main body section 61 displays the eye number on the display 65 through display controller 63. The main body section 61 advances the game using the eye number. It is noted that the eye number of the dice can be automatically reflected in a game or can be manually inputted based upon a player's judgment.

On the other hand, in the case of using only functions of the dice eye number determination section 60, the eye number determination result is processed independently of the game. Namely the main body section 61 executes only the processing to display the eye number determination result by the dice eye number determination section 60.

As explained above, incorporation of the dice eye number determination section 60 into the game apparatus serving mainly functions as the game machine allows the eye number result of the dice to be reflected during game-playing, thereby to shorten a waiting time for a game.

The game apparatus 50 may be equipped with a function connected to an internet (not shown in FIG. 23). Provision of this function allows a player to enjoy a game through an internet without use of a cassette ROM, CD software, DVD software, and the like, and in addition, game software can be downloaded from an internet.

In the above-mentioned preferred embodiments, the eye number determination is performed in order of “1”, “6”, “5”, “4”, “3”, and “2”. However, in a case only one dice is used by one player, the determination of the eye number “1” is not necessarily performed first. And the reason why the determination is performed in order from the large number to the small number (“6” . . . “2”) is that the processing for the small number of eyes is easier by determining the larger eye numbers first, thereby to shorten the entire processing time. However, random order may be performed.

And in the preferred embodiments, the dice is formed in a general square shape, but may be in a polygonal shape. In a case the dice is formed in a polygonal shape, the number of the eyes, in addition of “1”-“6”, may include “7” or more. In this case, corresponding sections in the processing shown above may be adopted and the processing program may be timely changed in accordance with the number of the eyes.

Further, the present invention can be applied to a dice with an eye in the shape of not only a point but also a diamond, a quadrangle or the like, or also to a dice on which a number is described, such as “1”, “2”, . . . , or to a dice on which a picture letter, a code or the like is displayed. In this case since the numbers are only recognized directly in place of image recognition of the points, the determination processing is simpler than the above-mentioned methods. The color of the eye (point) is generally black in addition of red, but points in other colors may be used.

The box 11 is formed in a square, but may be in another shape, for example, a cylindrical shape, or an oval shape. Further, a shape of the component corresponding to the box is not limited to a box shape and in particular, in FIG. 3, the image-shooting section may be formed by mounting a pole to a stand having a base of an L-letter shape or a reverse L-shape.

If the present invention is applied to a commercial product for schoolers, an appearance of the box may be imitated by a doll, an animal, a vehicle, a building or the like to establish a space at a part of the box for rolling a dice.

In FIG. 1, the reset switch 13 and the determination switch 17 are disposed in the box 11, but may be disposed in the main body side housing an electronic circuit therein. And if the program to actuate the reset at a certain cycle is incorporated in a ROM 4, the reset switch 13 can be omitted.

And in a case the eye of the eye number “1” is not red and is not the one black point of a large size, it is difficult to determine the eye number “1”. Accordingly, if a stick seal of a red point corresponding to the eye as the eye number “1” or a stick seal where a large black point is printed is enclosed/sold in selling a dice eye number determination apparatus 10, the above problem is solved.

Further, it is explained that in the preferred embodiments it is difficult to individually identify a plurality of dice based upon a boundary of each dice. However, a band-like line in black or silver is in advance attached to a ridge portion of a dice, thereby to clearly define the boundary of the dice when shot by the shooting section 1. As a result, the boundary allows a size of the dice to be image-recognized, which can be used as the kind determination.

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

1. A dice eye number determination method, comprising the steps of:
providing plural kinds of dice, each dice having at least six faces, describing from one eye to at least six eyes on each of at least the six faces, and having a feature to identify a player;
inputting the feature of the dice for each player by an inputting device or by shooting the feature by a shooting device;
recording the inputted or shot feature by a recording device;
shooting at least one of an upper face or a lower face of at least the six faces of each dice of the plural kinds of the dice to generate an image signal;
identifying a player, for each kind of the dice out of the plural kinds of the dice within the shot face based upon the recorded feature and the image signal; and
determining an eye number of each dice of the plural kinds of the dice within the shot face based upon the image signal.

2. The dice eye number determination method according to claim 1, wherein:
the eye number determination is performed in order of the each player or in order from an edge of the shot face with respect to the plurality of the dice.

3. The dice eye number determination method according to claim 1, wherein:
the feature to identify the each player comprises:
a display format such as a color, or a size or a font of eyes of each of the plurality of the dice;
a material of each of the plurality of the dice; or
an identification function in advance provided in each of the plurality of the dice.

4. The dice eye number determination method according to claim 1, wherein:
the eye described on each of the six faces is shown in at least one point and the eye number determination is made based upon a determination condition of at least one of a feature of the point, the number of the point, and a location state of the point within a predetermined area of the shot face.

5. The dice eye number determination method according to claim 4, wherein:
the eye number determination is made in such a way that whether or not the number of the point within the predetermined area of the shot face is one is first determined, and thereafter a determination of the eye numbers corresponding to “6”, “5”, “4”, “3”, and “2” is made.

6. A dice eye number determination apparatus, comprising:
plural kinds of dice, each dice having at least six faces and describing from one eye to at least six eyes on each of at least the six faces, and having a feature to identify a player; a shooting section to shoot at least one of an upper face or a lower face of at least the six faces of each dice of the plural kinds of the dice to generate an image signal; an input section to input the feature of the dice for each player for identifying the player;
a recording section to record the inputted feature;
a vessel wherein a space for rolling the plurality of the dice is defined and the shooting section is located in a lower part or an upper part thereof;
a determination section to identify the player for each kind of the dice out of the plural kinds of the dice within the shot face based upon the recorded feature and the image signal and determine an eye number of each of the plurality of the dice within the shot face based upon the image signal; and
an output section to display or output in a voice a determination result of the eye number for each player by the determination section as a numerical value or output the determination result as dice information of an electronic game.

7. The dice eye number determination apparatus according to claim 6, wherein:
the determination section performs the eye number determination in order of the each player or in order from an edge of the shot face with respect to the plurality of the dice.

8. The dice eye number determination apparatus according to claim 6, wherein:
the determination section identifies the each player by the feature based upon a display format such as a color, a size or a font of eyes of each of the plurality of the dice, a material of each of the plurality of the dice, or
an identification function in advance provided in each of the plurality of the dice.

9. The dice eye number determination apparatus according to claim 6, wherein:
the eye described on each of the six faces is shown in at least one point; and
the determination section performs the eye number determination based upon a determination condition of at least one of a feature of the point, the number of the point, and a location state of the point within a predetermined area of the shot face.

10. The dice eye number determination apparatus according to claim 9, wherein:
the determination section performs the eye number determination in such a way that whether or not the number of the point within the predetermined area of the shot face is one is first determined, and thereafter a determination of the eye numbers corresponding to “6”, “5”, “4”, “3”, and “2” is performed.

11. A game apparatus, comprising:
plural kinds of dice, each dice having at least six faces and describing from one eye to at least six eyes on each of at least the six faces, and having a feature to identify a player; a dice eye number determination section to identify the player for each kind of the dice out of the plural kinds of the dice within the shot face, as well as to determine an eye number of each of the plurality of the dice within the shot face based upon an image information provided by shooting at least one of an upper face or a lower face of at least the six faces of each dice of the plural kinds of the dice;
a control section programmed to:
perform a game by a memory medium storing a game software or a game provided by a connection to an internet;
display the image during performing the game on an internal or external display; and
display on the display, output in a voice, or incorporate into the game as necessary a determination result with regard to the eye determination for each player obtained by the dice eye number determination section.

12. The game apparatus according to claim 11, wherein:
the determination section performs the eye number determination in order of the each player or in order from an edge of the shot face with respect to the plurality of the dice.

13. The game apparatus according to claim 11, wherein:
the determination section identifies the each player by the feature based upon a display format such as a color, a size or a font of eyes of each dice of the plural kinds of the dice, a material of each dice of the plural kinds of the dice, or an identification function in advance provided in each dice of the plural kinds of the dice.

14. The game apparatus according to claim 11, wherein:
the eye described on each of the six faces is shown in at least one point; and
the determination section performs the eye number determination based upon a determination condition of at least one of a feature of the point, the number of the point, and a location state of the point within a predetermined area of the shot face.

15. The game apparatus according to claim 14, wherein:
the determination section performs the eye number determination in such a way that whether or not the number of the point within the predetermined area of the shot face is one is first determined, and thereafter a determination of the eye numbers corresponding to “6”, “5”, “4”, “3”, and “2” is performed.

16. A dice eye number determination game system, comprising:
a dice eye number determination apparatus comprising
plural kinds of dice, each dice having at least six faces and describing from one eye to at least six eyes on each of at least the six faces, and having a feature to identify a player, and
a dice eye number determination section to identify the player for each kind of the dice of the plural kinds of the dice within the shot face, as well as to determine an eye number of each dice of the plural kinds of the dice within the shot face based upon an image information provided by shooting at least one of an upper face or a lower face of at least the six faces of each dice of the plural kinds of the dice; and
a game performing apparatus comprising
a control section programmed to:
perform a game by a memory medium storing a game software or a game provided by a connection to an internet;
display the image during performing the game on an internal or external display; and
display on the display, output in a voice, or incorporate into the game as necessary a determination result with regard to the eye determination for each player obtained by the dice eye number determination apparatus.
